(19) United States
(12) Patent Application Publication
(10) Pub. No.: US 2014/0313023 A1
(43) Pub. Date: Oct. 23, 2014

(54) ACTIVE VEHICLE SAFETY SYSTEM AND A METHOD FOR OPERATION THEREOF

(71) Applicants: Chih-Kuei Hu, Tucson, AZ (US); Wei-Ting Liu, Hacienda Heights, CA (US); Wei-Hua Lu, Tucson, AZ (US)

(72) Inventors: Chih-Kuei Hu, Tucson, AZ (US); Wei-Ting Liu, Hacienda Heights, CA (US); Wei-Hua Lu, Tucson, AZ (US)

(21) Appl. No.: 13/833,032

(22) Filed: Mar. 15, 2013

(51) Int. Cl. B60Q 9/00; G07C 5/00; G08B 21/18

(52) U.S. Cl. CPC B60Q 9/00; G08B 21/187; G07C 5/00
USPC 340/436; 340/459

(57) ABSTRACT

A vehicle safety system includes a sensing unit arranged on a master vehicle for detecting the occurrence of a predefined event and an active protection unit for triggering a protection function of a slave vehicle. A wireless signal transmitting unit is arranged on the master vehicle for transmitting a wireless signal to the slave vehicle when the predefined event is detected. A wireless signal receiving unit is arranged on the slave vehicle for receiving the wireless signal from the master vehicle. The active protection unit triggers the protection function of the slave vehicle after receiving the wireless signal.

### BACKGROUND OF THE INVENTION

1. Field of the Invention

The present invention relates to an active vehicle safety system, and more particularly, to an active vehicle safety system capable of automatically transmitting a warning signal to surroundings. The present invention furthermore relates to a method for operation in the active vehicle safety system.

2. Description of the Prior Art

In order to increase safety in traffic, active as well as passive systems for further improving safety in traffic are continuously developed. Passive safety systems are directed toward reducing the effect of an accident, in the event an accident takes place. On the other hand, active safety systems are directed toward reducing the probability of occurrence of accidents.

The conventional active safety system seeks to detect threats outside the vehicle by a sensor system. The sensor system detects distance and speed of nearby vehicles, pedestrians or obstacles to warn the driver in advance and reduce the probability of occurrence of accidents.

### SUMMARY OF THE INVENTION

It is therefore a primary objective of the claimed invention to provide an active vehicle safety system and operating method thereof. The claimed invention utilizes a totally different operation to reduce the probability of occurrence of accidents. When a driver or a vehicle has possible hazardous situations happened, the claimed invention can transmit a warning notice to nearby vehicles or to traffic control center.

An embodiment of the invention discloses a vehicle safety system. The vehicle safety system comprises a master vehicle, a sensing unit arranged on the master vehicle, and a wireless signal transmitting unit arranged on the master vehicle. The sensing unit is used for detecting the occurrence of a predefined event, and the wireless signal transmitting unit is used for transmitting a wireless signal to surrounding when the predefined event is detected.

Another embodiment of the invention discloses a vehicle safety system. The vehicle safety system comprises a slave vehicle, a wireless signal receiving unit arranged on the slave vehicle, and an active protection unit arranged on the slave vehicle. The wireless signal receiving unit is used for receiving an external warning signal, and the active protection unit is used for triggering a protection function of the slave vehicle after receiving the external warning signal.

A further embodiment of the invention discloses a vehicle safety system. The vehicle safety system comprises a master vehicle and a slave vehicle. A sensing unit is arranged on the master vehicle for detecting the occurrence of a predefined event. A wireless signal transmitting unit is arranged on the master vehicle for transmitting a wireless signal to the slave vehicle when the predefined event is detected. A wireless signal receiving unit is arranged on the slave vehicle for receiving the wireless signal from the master vehicle. An active protection unit is used for triggering a protection function of the slave vehicle after receiving the wireless signal.

A further embodiment of the invention discloses a method for operation in an active vehicle safety system. The method comprises detecting a predefined event of a master vehicle, triggering a signal transmitting unit in the master vehicle to transmit a wireless signal when the predefined event is detected, receiving the wireless signal by a receiving unit in a slave vehicle, and triggering a protection function in the slave vehicle.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the first embodiment according to the present invention.

FIG. 2 is a schematic diagram of the master vehicle of the first embodiment according to the present invention.

FIG. 3 is a schematic diagram of the slave vehicle of the first embodiment according to the present invention.

FIG. 4 is a schematic diagram of the first embodiment according to the present invention.

FIG. 5 is a schematic diagram of the second embodiment according to the present invention.

FIG. 6 is a schematic diagram of the third embodiment according to the present invention.

FIG. 7 is a flow chart of a method for operation in the active vehicle safety system according to the present invention.

### DETAILED DESCRIPTION

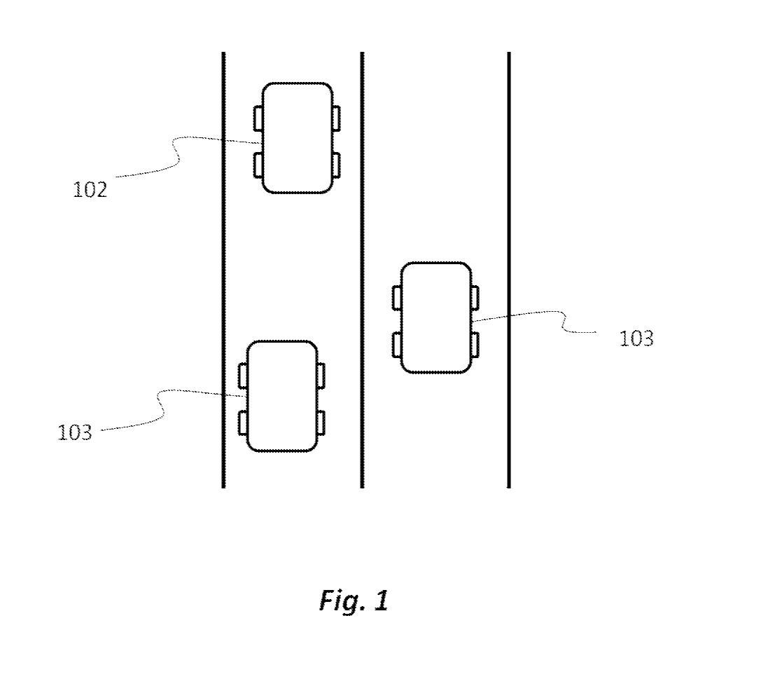

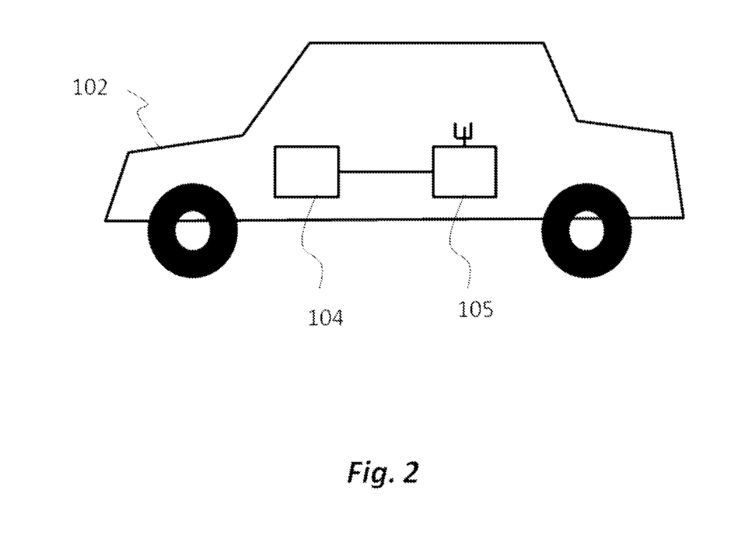

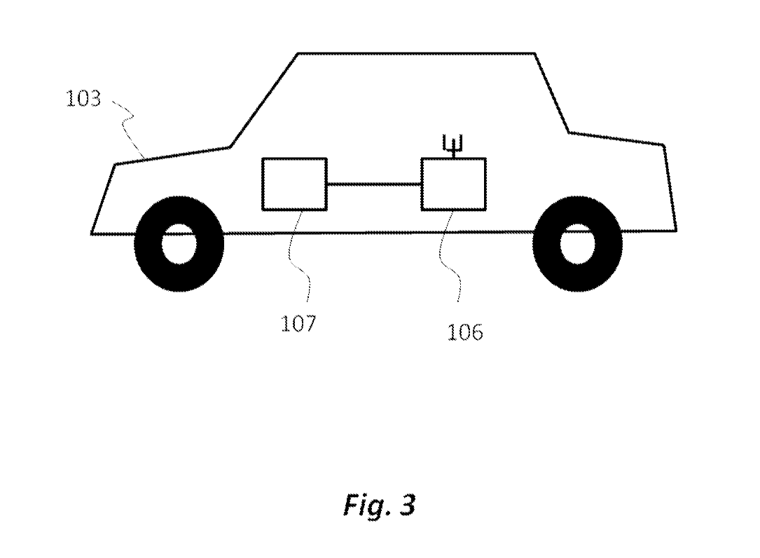

Please refer to FIG. 1, which is a first embodiment of the active vehicle safety system according to the present invention. In FIG. 1, the vehicle 102 moves on the lane and the vehicle 103 is near to the vehicle 102. Please refer to FIG. 2 and FIG. 3. In the present invention, a sensing unit 104 is installed in the vehicle 102 for detecting some situations of the vehicle 102, such as the tire pressure, the collision event, the tire slip event, the mechanism issues, or other electronic device issues. According to the sensing results, some events can be defined as the emergency situation in advance when setting up the sensing unit 104. For example, a flat tire or a collision accident is defined as an emergency situation.

The sensing unit 104 can further detect the driver's behavior according to some hardware detectors, such as the emergency brake, the steering wheel turning speed, the driving speed, or the blinking frequency of the driver's eyelids. According to the sensing results, some events of the driver's behaviors can be defined as the hazardous driving behaviors in advance when setting up the sensing unit 104. For example, when the driver steps on the brake suddenly and strenuously, or when the driver turns the steering wheel suddenly and strenuously, it will be defined as a hazardous driving behavior.

When the sensing unit 104 detects any of the emergency situations of the vehicle 102 or detects any of the hazardous driving behaviors of the driver, the sensing unit 104 can trigger the signal transmitting unit 105. The signal transmitting unit 105 is installed on the vehicle 102 to transmit a wireless signal to surrounding. The wireless signal can be simply a warning signal or can be a warning signal accompanying with information of the emergency type. For example, the information includes the emergency situations of the vehicle 102 and the vehicle type of the vehicle 102. For example, the information can include that the vehicle 102 is a truck having a flat tire or the vehicle 102 is a bus having an emergency brake.

Please refer to FIG. 3, a signal receiving unit 106 is installed on the vehicle 103 for receiving the wireless signal transmitted by the vehicle 102. After receiving the wireless signal, the signal receiving unit 106 can trigger the active protection unit 107 to warn or protect driver and passengers in the vehicle 103. The active protection unit 107 can be a visual or acoustic warning function, such as a warning flash light or a warning beep, to remind the driver in the vehicle 103 that an emergency situation is happening ahead. The warning function can further include the emergency situation and the vehicle type. For example, different colors of the warning flash light or different frequencies of the warning beep can show different information of the emergency situation, such as a truck having a flat tire locates 100 meters in front of the vehicle 103.

In another embodiment, the slave vehicle further comprises a voice system. Whenever the wireless signal is received, the voice system can speak the emergency situation. For example, if there is a truck having a flat tire in front of the slave vehicle, the voice system speaks “A truck has a flat tire in fount of you”.

Further, the active protection unit 107 can be connected to the mechanism or electronic equipment of the vehicle 103. For example, after receiving the wireless warning signal transmitted by the vehicle 102, the active protection unit 107 in the vehicle 103 can turn on the traction control system, pre-charge the brake system, or tighten the seat belt in advance to protect driver and passengers in the vehicle 103.

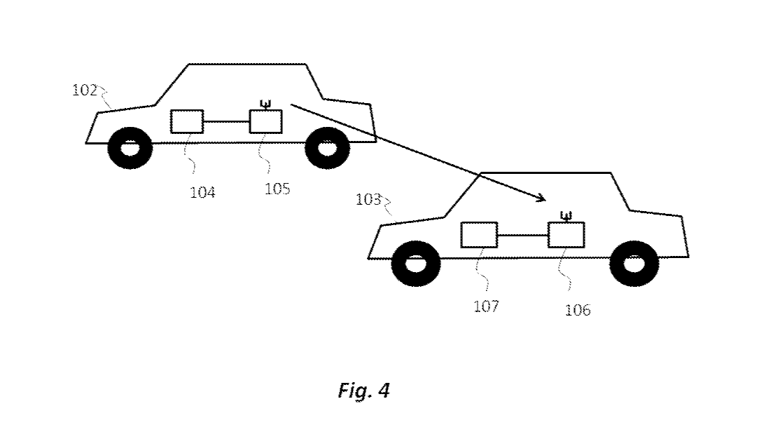

Please refer to FIG. 4, which is another representation of the first embodiment of the active vehicle safety system according to the present invention. In FIG. 4, the vehicle 102, or called the master vehicle in the active vehicle safety system, transmits a wireless warning signal to nearby area through the signal transmitting unit 105 when the sensing unit 104 detects an emergency situation or a hazardous driving behavior. The vehicle 103, or called the slave vehicle in the active vehicle safety system, receives the wireless warning signal through the signal receiving unit 106 and triggers the active protection unit 107. The active protection unit 107 can warn the driver or turn on the safety equipments of the vehicle 103 to avoid an accident.

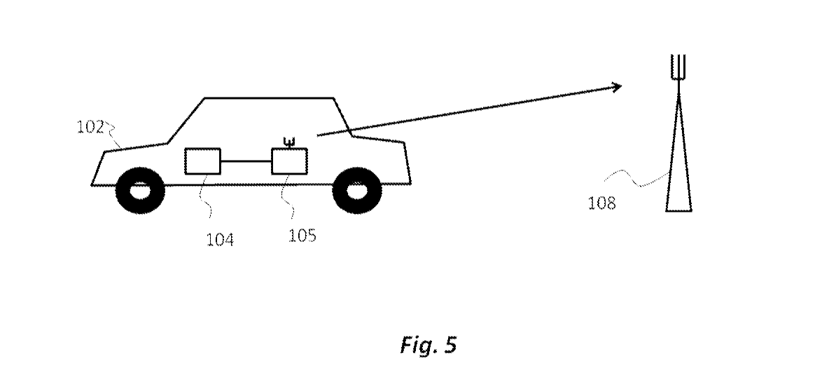

Please refer to FIG. 5, which is a second embodiment of the active vehicle safety system according to the present invention. The second embodiment of the active vehicle safety system includes a vehicle 102 and a control center 108. When the sensing unit 104 detects any emergency situations of the vehicle 102 or detects any hazardous driving behaviors of the driver, the sensing unit 104 can trigger the signal transmitting unit 105. The signal transmitting unit 105 can transmit a wireless signal to the control center 108. The wireless signal can be simply a warning signal or can be a warning signal accompanying with information of the emergency type. For example, the information includes the emergency situations of the vehicle 102 and the vehicle type of the vehicle 102. For example, the information can include that the vehicle 102 is a truck having a flat tire or the vehicle 102 is a bus having an emergency brake. When the control center 108 receives the wireless signal, an emergency management can be activated immediately.

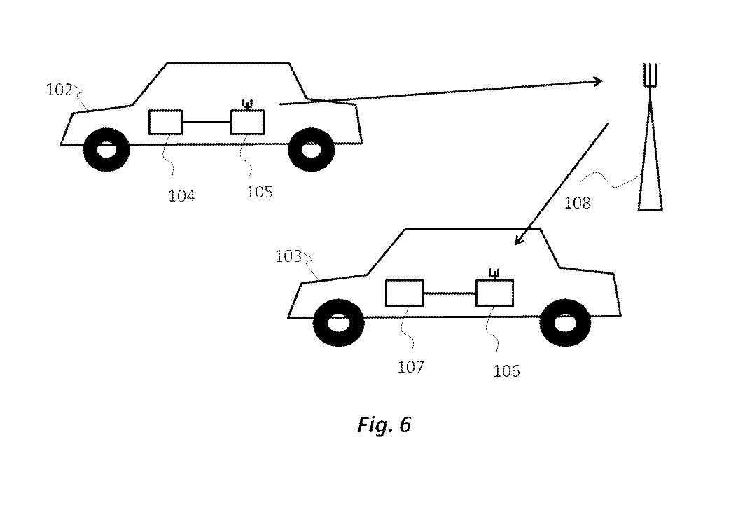

Please refer to FIG. 6, which is a third embodiment of the active vehicle safety system according to the present invention. When the sensing unit 104 detects any emergency situations of the vehicle 102 or detects any hazardous driving behaviors of the driver, the sensing unit 104 can trigger the signal transmitting unit 105. The signal transmitting unit 105 can transmit a wireless signal to the control center 108. The wireless signal can be simply a warning signal or can be a warning signal accompanying with information of the emergency type. For example, the information includes the emergency situations of the vehicle 102 and the vehicle type of the vehicle 102. For example, the information can include that the vehicle 102 is a truck having a flat tire or the vehicle 102 is a bus having an emergency brake. When the control center 108 receives the wireless signal, the control center 108 will send out a warning signal or warning information immediately to other vehicles 103 nearby the vehicle 102 to protect driver and passengers in the vehicle 103.

In a further embodiment of the present invention, the signal transmitting unit 105 can be installed on the police car, the fire engine or the ambulance. In the situations that a police car is chasing another car, a fire engine is going to a fire place, or an ambulance is on duty, the present invention can protect not only the police car, the fire engine or the ambulance but also the nearby vehicles. In this situation, the police car, the fire engine or the ambulance will send out a warning signal or warning information to the nearby area or to the control center 108. The control center 108 will send out a warning signal or warning information immediately to vehicles on the expected path of the police car, the fire engine or the ambulance. The police car, the fire engine or the ambulance can also send out a warning signal or warning information to the nearby area, and other vehicles can dodge quickly to avoid any accident.

After receiving the warning signal or warning information from the control center 108, the signal receiving unit 106 can trigger the active protection unit 107 to warn or protect driver and passengers in the vehicle 103. The active protection unit 107 can be a visual or acoustic warning function, such as a warning flash light or a warning beep, to remind the driver in the vehicle 103 that an emergency situation is happening ahead. The warning function can further include the emergency situation and the vehicle type. For example, different colors of the warning flash light or different frequencies of the warning beep can show different information of the emergency situation, such as a truck having a flat tire locates 100 meters in front of the vehicle 103.

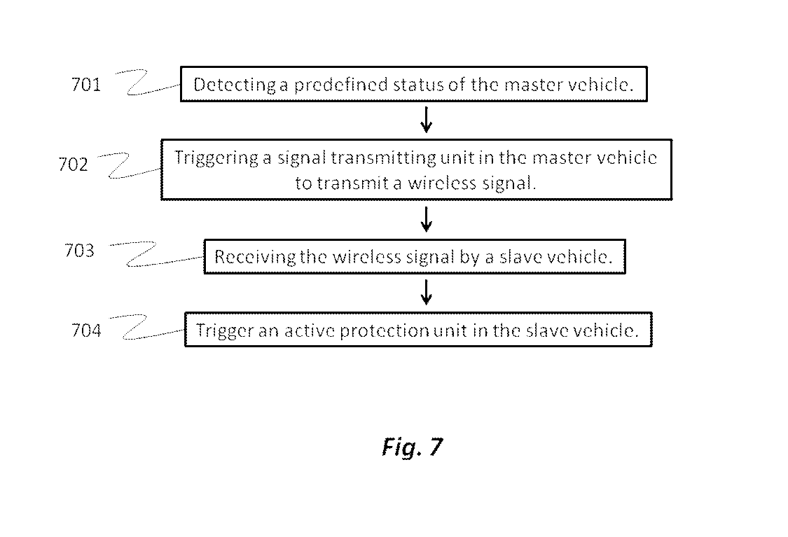

Please refer to FIG. 7, which is a flow chart of a method for operation in the active vehicle safety system according to the present invention. The active vehicle safety system includes a master vehicle and a slave vehicle. In the step 701, a sensing unit detects some predefined situations of the master vehicle. The sensing unit is installed in the master vehicle, and some vehicle situation is defined as emergency status in advance when setting up the sensing unit. For example, the predefined situations include the tire pressure, the collision event, the tire slip event, the mechanism issues, or other electronic device issues. Furthermore, the predefined situations can be driver's behavior, such as the emergency brake, the steering wheel turning speed, the driving speed, or the blinking frequency of the driver's eyelids.

When an emergency status is detected by the sensing unit, in the step 702, the system will trigger a signal transmitting unit to transmit a wireless signal. The signal transmitting unit is installed in the master vehicle, and the wireless signal can be simply a warning signal or can be a warning signal accompanying with information of the emergency type. For example, the information includes the emergency situations and the vehicle type of the master vehicle. For example, the information can include that the master vehicle is a truck having a flat tire or the master vehicle is a bus having an emergency brake.

In the step 703, a signal receiving unit installed in the slave vehicle receives the wireless signal from the master vehicle. After receiving the wireless signal, in the step 704, the signal receiving unit will trigger the active protection unit in the slave vehicle to warn or protect driver and passengers in the slave vehicle. The active protection unit can be a visual or acoustic warning function, such as a warning flashlight or a warning beep, to remind the driver in the slave vehicle that an emergency situation is happening ahead. The warning function can further include the emergency situation and the vehicle type. For example, different colors of the warning flash light or different frequencies of the warning beep can show different information of the emergency situation, such as a truck having a flat tire locates 100 meters in front of the slave vehicle. Further, the active protection unit can be connected to the mechanism or electronic equipment of the slave vehicle. For example, after receiving the wireless warning signal transmitted by the master vehicle, the active protection unit in the slave vehicle can turn on the traction control system, pre-charge the brake system, or tighten the seat belt in advance to protect driver and passengers in the slave vehicle.

Those skilled in the art will readily observe that numerous modifications and alterations of the device and method may be made while retaining the teachings of the invention.

What is claimed is:

1. A vehicle safety system comprising:
a master vehicle, comprising:
a sensing unit arranged on the master vehicle for detecting the occurrence of a predefined event; and
a wireless signal transmitting unit arranged on the master vehicle for transmitting a wireless signal when the predefined event is detected; and
a slave vehicle, comprising:
a wireless signal receiving unit arranged on the slave vehicle for receiving the wireless signal from the master vehicle; and
an active protection unit for triggering a protection function of the slave vehicle after receiving the wireless signal.

2. The vehicle safety system of claim 1, wherein the predefined event is an abnormal situation of the master vehicle.

3. The vehicle safety system of claim 2 wherein the abnormal situation is the collision of the master vehicle, the slip of the master vehicle, the mechanism issue of the master vehicle, or the tire abnormality of the master vehicle.

4. The vehicle safety system of claim 1, wherein the predefined event is: a police car is on duty, an ambulance is on duty or a fire engine is on duty.

5. The vehicle safety system of claim 1, wherein the predefined event is a hazardous behavior of the driver of the master vehicle.

6. The vehicle safety system of claim 5, wherein the hazardous behavior of the driver is the emergency brake, the unusual steering wheel turn, or the speeding driving.

7. The vehicle safety system of claim 1, wherein the protection function is a warning to the driver, a safety mechanism of the slave vehicle, or an auto brake function of the slave vehicle.

8. A method for operation in an active vehicle safety system comprising:
detecting a predefined event of a master vehicle;
triggering a signal transmitting unit in the master vehicle to transmit a wireless signal when the predefined event is detected;
receiving the wireless signal by a receiving unit in a slave vehicle; and
triggering a protection function in the slave vehicle.

9. The method of claim 8, wherein the predefined event is an abnormal situation of the master vehicle or a hazardous behavior of the driver of the master vehicle.

10. The method of claim 8, wherein the protection function is a warning to the driver, a safety mechanism of the slave vehicle, or an auto brake function of the slave vehicle.

11. A master vehicle capable of generating a wireless signal indicating a predefined event condition of the master vehicle, the master vehicle comprising:
a sensing unit arranged on the master vehicle for detecting the occurrence of the predefined event; and
a wireless signal transmitting unit arranged on the master vehicle for transmitting the wireless signal when the predefined event is detected.

12. The master vehicle of claim 11, wherein the predefined event is an abnormal situation of the master vehicle.

13. The master vehicle of claim 12, wherein the abnormal situation is the collision of the master vehicle, a slip of the master vehicle, a mechanism issue of the master vehicle, or a tire abnormality of the master vehicle.

14. The master vehicle of claim 11, wherein the predefined event is: a police car is on duty, an ambulance is on duty or a fire engine is on duty.

15. The master vehicle of claim 11, wherein the predefined event is a hazardous behavior of the driver of the master vehicle.

16. The master vehicle of claim 15, wherein the hazardous behavior of the driver is an emergency brake, an unusual steering wheel turn, or a speeding driving.

17. The master vehicle of claim 11, wherein the wireless signal transmitting unit transmits the wireless signal to a slave vehicle nearby the master vehicle.

18. The master vehicle of claim 17, wherein the wireless signal is transmitted to the slave vehicle for warning the occurrence of the predefined event of the master vehicle.

19. The master vehicle of claim 11, wherein the wireless signal further indicates a vehicle type of the master vehicle.

20. A slave vehicle comprising:
a wireless signal receiving unit arranged on the slave vehicle for receiving an external warning signal; and
an active protection unit for triggering a protection function of the slave vehicle after receiving the external warning signal.

21. The slave vehicle of claim 20, wherein the external warning signal is transmitted by a master vehicle nearby the slave vehicle or by a control center.

22. The slave vehicle of claim 20, wherein the protection function is a warning to the driver, a safety mechanism of the slave vehicle, or an auto brake function of the slave vehicle.

23. A vehicle safety system comprising:
a master vehicle, comprising:
a sensing unit arranged on the master vehicle for detecting the occurrence of a predefined event; and
a wireless signal transmitting unit arranged on the master vehicle for transmitting a first wireless signal when the predefined event is detected; and
a control center for receiving the first wireless signal from the master vehicle and transmitting an external warning signal.

24. The vehicle safety system of claim 23, further comprising:
a slave vehicle, comprising:
a wireless signal receiving unit arranged on the slave vehicle for receiving the external warning signal from the control center or receiving a first wireless signal from the master vehicle; and
an active protection unit for triggering a protection function of the slave vehicle after receiving the second wireless signal.

25. The vehicle safety system of claim 24, wherein the predefined event is an abnormal situation of the master vehicle.

26. The vehicle safety system of claim 25, wherein the abnormal situation is the collision of the master vehicle, the slip of the master vehicle, the mechanism issue of the master vehicle, or the tire abnormality of the master vehicle.

27. The vehicle safety system of claim 23, wherein the predefined event is: a police car is on duty, an ambulance is on duty or a fire engine is on duty.

28. The vehicle safety system of claim 23, wherein the predefined event is a hazardous behavior of the driver of the master vehicle.

29. The vehicle safety system of claim 28, wherein the hazardous behavior of the driver is the emergency brake, the unusual steering wheel turn, or the speeding driving.

30. The vehicle safety system of claim 24, wherein the protection function is a warning to the driver, a safety mechanism of the slave vehicle, or an auto brake function of the slave vehicle.
